(19) United States
(12) Patent Application Publication
(10) Pub. No.: US 2014/0059225 A1
(43) Pub. Date: Feb. 27, 2014

(54) NETWORK CONTROLLER FOR REMOTE SYSTEM MANAGEMENT

(71) Applicants: Iosif Gasparakis, Shannon (IE); Ilango S. Ganga, Cupertino, CA (US); Peter P. Waskiewicz, JR., Portland, OR (US)

(72) Inventors: Iosif Gasparakis, Shannon (IE); Ilango S. Ganga, Cupertino, CA (US); Peter P. Waskiewicz, JR., Portland, OR (US)

(21) Appl. No.: 13/590,631

(22) Filed: Aug. 21, 2012

(51) Int. Cl. H04L 29/08

(52) U.S. Cl. CPC H04L 29/0818
USPC 709/226

(57) ABSTRACT

Generally, this disclosure describes a network controller for remote system management. A host device may include the network controller and a programmable network element. The network controller may include controller circuitry configured to acquire network management data related to operation of the network controller and to receive host management data related to operation of the host device. The network controller may further include a transmitter configured to transmit the network and host management data to a management system remote from the network controller and a receiver configured to receive a command from the management system related to the management data, the command configured to reprogram the programmable network element to change a behavior of the programmable network element.

### FIELD

This disclosure relates to a network controller, and, more particularly, to a network controller for remote system management.

### BACKGROUND

Automation of server and network management is an area of interest in data centers, including data centers utilized for providing cloud computing services-both public and private. Remote server and network management can facilitate automation of server and network management. A management system may monitor network performance and may be configured to adjust flows and workloads based on policy. Some network systems may include programmable network elements (e.g., OpenFlow) facilitating adjustments based on network performance.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1A illustrates an example network system consistent with various embodiments of the present disclosure;

FIG. 1B illustrates an example of a network controller consistent with various embodiments of the present disclosure;

FIG. 2 is an example of a virtual machine architecture consistent with one embodiment of the present disclosure;

FIG. 3 illustrates a flowchart of exemplary operations of a network controller consistent with one embodiment of the present disclosure; and

FIG. 4 illustrates a flowchart of exemplary operations of a management system consistent with one embodiment of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure describes a network controller configured to facilitate remote system management of a networked system. The network controller is configured to gather management data related to a networked system, e.g., a host device. The management data may include network management data related to the network controller (e.g., traffic and/or performance information) and host management data related to operation and status of the host device (e.g., power supply status, CPU usage, memory usage, etc.). The network management data and at least some of the host management data may be acquired without involving host processor(s). The network controller is further configured to transmit the management data to a remote management system, to receive resulting commands from the management system and to provide those commands to the host device. For example, the management data may be transmitted and received via a management channel established between the host device and the management system. The received commands may be configured to affect, e.g., flow control and/or operations of the host device. If a target component of the host device is programmable (e.g., a programmable switch), then the command may be configured to reprogram the target component.

The management system is configured to analyze the received management data and to generate the commands based, at least in part, on policy. The management system may integrate network management and system (e.g., host) management. The management system may thus adaptively respond to host device workload and/or network workload and to use the management data for, e.g., scheduling workloads, workload placement, forwarding policy, enforcement, etc. The management data from the network controller may thus provide the management system with accurate locally acquired management data related to the associated node.

Acquiring the management data may thus be off-loaded from a host processor to the network controller. For programmable network elements included in the host device, the commands received from the management system may be used to reconfigure the programmable network elements. Thus, host device operations may be managed remotely without burdening the host device processor(s). Further, the management system may be provided accurate management data related to operation of the host device including network management data related to operation of the network controller and host management data related to operation of the host device and accessible, for example, by a Baseboard Management Controller (BMC) and/or a bridge controller.

The management system may receive management data from a plurality of host devices coupled to the management system via a network. The network may include one or more programmable network elements, i.e., may be a software-defined network. The management system may be configured to generate one or more commands based, at least in part, on the received management data, network system data and/or network system policies. Each command may be configured to program or reprogram a programmable network element. The programmable network element may be included in the network, a host device and/or a network controller. Such programming (and reprogramming) is configured to change a behavior of the programmable network element, e.g., forwarding behavior of a programmable switch. Thus, the behavior of a software-defined network may be controlled by a centralized management system based, at least in part, on management data received from one or more host devices.

Programmable network elements may be supplied by a plurality of manufacturers. Programmability of each programmable network element may be provided by an application programming interface (API). The API may then be utilized by the management system to modify the behavior of the programmed network element. An API may be manufacturer-specific or may be configured to modify the behavior of a programmable network element regardless of the programmable network element manufacturer. For example, OpenFlow includes APIs configured to modify the behavior of a programmable network element regardless of the programmable network element manufacturer, as will be discussed below.

Host management data may include internal state(s) and/or resource allocations of the host device elements, including but not limited to statistics, performance register data, sensor measurements, e.g., power supply status, utilization data associated with host device processor(s), e.g., CPU usage, memory usage, etc. Network management data may include utilization data associated with the network controller. Network management data may include, but is not limited to, number of ports per interface, numbers of dropped packets per port, whether a link is full or half duplex link, link speed, flow control status (e.g., enabled/disabled). Network controller data may include, link statistics, link utilization or usage, e.g., transmit and receive throughput of physical link, sent and received packets, dropped packets, error counts, flow control usage, Energy efficient Ethernet usage statistics, etc. In an embodiment, some of the data like QoS, throughput etc., may also be collected on a virtual interface (or per VM) basis on a virtualized system. The management system may then determine load distribution, forwarding policies, flow assignments, etc., based, at least in part, on the received management data, and forward related commands to the host device via the network controller. In some embodiments, management data and commands may be utilized for power management via the network controller and Baseboard Management Controller (BMC), as will be described in more detail below.

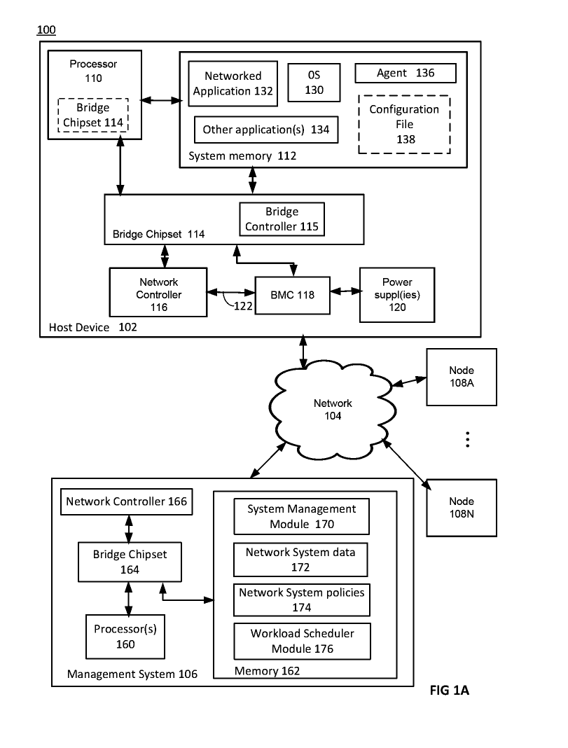

FIG. 1 illustrates an example network system 100 consistent with various embodiments of the present disclosure. The system 100 generally includes a host device 102 configured to communicate with a management system 106 and/or at least one node 108A, . . . , 108N, via network 104. For example, the host device 102 may be a server configured to execute one or more applications and/or workloads in, e.g., a datacenter. Network 104 may include network element(s) (e.g., a switch, a bridge and/or a router (wired and/or wireless)), additional network(s), and/or a combination thereof.

For example, network 104 may include a switch configured to couple a plurality of computing devices, e.g., when network system 100 is included in a data center. Network 104 may include any packet-switched network such as, for example, Ethernet networks as set forth in the IEEE 802.3 standard and/or a wireless local area network such as, for example, IEEE 802.11 standard.

In another example, network 104 may be configured as a software defined network. For example, the software defined network may be configured to separate control from data so that control signals may be transmitted and/or received separate from data frames and/or packets. One or more network elements of a software defined network may be programmable (locally and/or remotely). Such network elements may then be provided with an application programming interface (API) to facilitate such programmability.

For example, embodiments may employ a software-based switching system designed to interact with features already present in existing network devices to control information routing in, e.g., packet switched networks. OpenFlow, as set forth in the OpenFlow Switch Specification Version 1.1.0 Implemented (Wire Protocol 0x02) dated Feb. 28, 2011, is an example of a software-based switching system that was developed for operations on packet switched networks like Ethernet. OpenFlow may interact using features that are common to network devices that are not manufacturer-specific. In particular, OpenFlow provides a secure interface for controlling the information routing behavior of various commercial Ethernet switches, or similar network devices, regardless of the device manufacturer. OpenFlow is one example of a software-defined switching system. Other software and/or hardware based switching systems may be utilized configured to provide flow control in a packet-switched network, consistent with various embodiments of the present disclosure.

Each of the nodes 108A, . . . , or 108N is configured to communicate with each other node 108A, . . . , 108N and/or the management system 106 via network 104. One or more nodes 108A, . . . , 108N may correspond to a host device similar to host device 102. “Node” corresponds to a computing device, including, but not limited to, a general purpose computer (e.g., desktop computer, laptop computer, tablet computer, etc.), a server, a blade, etc. Thus, host device 102 is one example of a node.

The host device 102 generally includes a processor 110, a system memory 112, a bridge chipset 114 and a network controller 116. The bridge chipset 114 may include a bridge controller 115. The host device 102 may include a baseboard management controller (BMC) 118 and one or more power supplie(s) 120. The processor 110 is coupled to the system memory 112. The network controller 116 is configured to couple the host device 102 to the network 104. In an embodiment, the bridge chipset 114 may be coupled to the processor 110. In this embodiment, the bridge chipset 114 may also be coupled to the system memory 112, the network controller 116 and the BMC 118. In another embodiment, the bridge chipset 114 may be included in the processor 110. In this embodiment, the processor 110 (and integral bridge chipset 114) may also be coupled to network controller 116 and BMC 118.

The system memory 112 is configured to store an operating system OS 130, a networked application 132 and other applications 134. The system memory may be further configured to store an agent 136 and a configuration file 138, as described herein. The networked application 132 may be configured to communicate via network 104 with another application executing, for example, on node 108A. For example, the networked application 132 may be configured to send application data to node 108A via network controller 116.

Network controller 116 is configured to couple host device 102 to node(s) 108A, . . . , 108N and/or management system 106 via network 104. For example, network controller 116 may couple networked application 132 to node 108A and may thus manage communication of network application data to node 108A. In an embodiment, network controller 116 is configured to gather management data related to host device 102, including from the network controller 116 itself, agent 136, BMC 118 and/or bridge controller 115. The agent 136 may be configured to communicate with firmware, as described herein. The network controller 116 is further configured to communicate the management data to management system 106 and to receive commands from management system 106, based, at least in part on the transmitted management data.

FIG. 1B illustrates a more detailed example of a network controller 116 consistent with various embodiments of the present disclosure. Network controller 116′ is configured to manage communication of application data (e.g., related to networked application 132) between host device 102, network 104 and/or nodes 108A, . . . , 108N. Network controller 116′ is further configured to implement remote system management in coordination with management system 106, as described herein.

Network controller 116′ includes controller circuitry 140, transmitter/receiver Tx/Rx 142, interface circuitry 141 and buffers 144. Controller circuitry 140 includes processor circuitry 146 and memory 148 configured to store controller management module 150 and configuration data 152. Memory 148 may be volatile, non-volatile and/or a combination thereof. Interface circuitry 141 is configured to couple network controller 116, 116′ to BMC 118 and/or bridge chipset 114. Buffers 144 are configured to store application data for transmission and/or received data. In some embodiments, network controller 116′ may include switch circuitry 147 configured to switch network traffic, e.g., between a plurality of processors included in processor 110 and/or a plurality of virtual machines. Switch circuitry 147 may include, for example, a software controlled switch. Tx/Rx 142 includes a transmitter configured to transmit messages and a receiver configured to receive messages that may include application data. Tx/Rx 142 is further configured to transmit management data from network controller 116′ and to receive command information from management system 106 as described herein.

Controller circuitry 140 may include, but is not limited to, a microcontroller, a microengine, an application-specific integrated circuit (ASIC), a field programmable gate array (FPGA) and/or any other controller circuitry that is generally capable of performing typical network controller functions. For example, a microengine may include a programmable microcontroller. Processor circuitry 146 may be a relatively less capable processor than a general purpose processor. In some embodiments, controller circuitry 140 may include a more powerful, e.g., a general purpose processor. The functionality of the network controller related to remote system management may be performed on the relatively less capable processor generally available in many network controllers and/or may be performed on a more powerful general purpose processor.

Processor circuitry 146 may be configured to execute controller management module 150 to perform operations associated with remote system management, as described herein. For example, controller management module 150 may be embodied as firmware resident in controller circuitry 140. In another example, controller management module 150 programmed into controller circuitry 140 by field-programming, e.g., FPGA. Processor circuitry 146 may be further configured to access configuration data 152 to determine the management data to be collected and provided to the management system.

Controller circuitry 140 is configured to acquire network management data related to operation of the network controller 116′. Controller circuitry 140 may be configured to receive host management data related to operation of the host device 102 from, e.g., agent 136, bridge controller 115 and/or the BMC 118. The management data collected may be based, at least in part, on configuration data 152. For example, the configuration data may be stored in configuration file 138 in system memory 112. Upon host device 102 power up and/or reset, agent 136 may be configured to retrieve configuration data from configuration file 138 and to provide the configuration data 152 to network controller 116′ for storage in memory 148. In another example, the configuration data may be provided to the controller circuitry 140 via BMC 118. In another example, the configuration data 152 may be stored in memory 148 at provisioning of host device 102. In another example, configuration data 152 may be provided to network controller 116′ from management system 106.

Controller circuitry 140 is configured to acquire network management data related to the operation of the network controller 116′. Network controller management data includes, but is not limited to, utilization data associated with the network controller such as, for example, number of ports per interface, numbers of dropped packets per port, whether a link is full or half duplex link, link speed, flow control status (e.g., enabled/disabled), flow control events, retransmits and/or requeues.

Network management data may include, but is not limited to, number of ports per interface, numbers of dropped packets per port, whether a link is full or half duplex link, link speed, flow control status (e.g., enabled/disabled). Network controller data may include, link statistics, link utilization or usage, e.g., transmit and receive throughput of physical link, sent and received packets, dropped packets, error counts, flow control usage, Energy efficient Ethernet usage statistics, etc. In an embodiment, some of the data like QoS, throughput etc., may also be collected on a virtual interface (or per VM) basis on a virtualized system.

The agent 136 may be configured to acquire agent management data related to host device 102, processor 110 and/or system memory 112. Thus, host management data may include agent management data. For example, agent 136 may be configured to capture processor usage data (e.g., CPU percent usage), memory usage, cache memory usage, host storage statistics (e.g., Read/Writes per second, total storage space, total storage space available), data readings from sensors (such as power consumption, temperature readings, voltage fluctuations), etc. In systems configured with Virtual Machines (VMs), an agent in a Virtual Machine Monitor (VMM) may be configured to provide VM resource usage including, but not limited to virtual CPU resources, memory resources, bandwidth usage, etc. The agent 136 may be configured to acquire the management data, e.g., at time intervals and to provide the agent management data to the controller circuitry 140. Operations of the agent 136 may have a relatively minor effect on the processing load associated with processor 110. For example, agent management data may be provided to controller circuitry 140 via a direct memory access operation.

The BMC 118 may be coupled to the network controller 116 by a system management bus 122. Coupling the network controller 116 and BMC 118 is configured to facilitate direct communication between the network controller 116 and the BMC, that does not include the bridge chipset 114. The BMC 118 is configured to acquire BMC management data and to provide the BMC management data to the network controller 116 via system management bus 122. BMC management data may include data related to a state of the host device. Thus, host management data may include BMC management data.

The BMC 118 may implement a platform management interface architecture such as, for example, the Intelligent Platform Management Interface (IPMI) architecture, defined under the Intelligent Platform Management Interface Specification v 2.0, published Feb. 14, 2004 by Intel, Hewlett-Packard, NEC and Dell, and/or later versions of this specification. “Platform management” refers to monitoring and control functions that may be built into platform (e.g., host device 102) hardware and are primarily used for monitoring health of the host device hardware. For example, monitoring may include monitoring host device 102 temperatures, voltages, fans, power supplies 120, bus errors, system physical security, etc. Platform management may further include recovery capabilities such as local or remote system resets and power on/off operations. For example, management system 106 may be configured to provide BMC management commands (e.g., to power off or power on) to network controller 116 based on received BMC management data provided to the management system 106.

The network controller 116, BMC 118 and/or management system 106 may be configured to provide “Energy-Efficient Ethernet” capability as defined in IEEE standard IEEE Std 802.3az™-2010 (hereinafter “EEE”), titled “IEEE Standard for Information Technology-Telecommunications and information exchange between systems-Local and metropolitan area networks-Specific requirements Part 3: Carrier Sense Multiple Access with Collision Detection (CSMA/CD) Access Method and Physical Layer Specifications, Amendment 5: Media Access Control Parameters, Physical Layers, and Management Parameters for Energy-Efficient Ethernet”, published October, 2010, by the Institute of Electrical and Electronic Engineers, and compatible and/or later versions of this standard. EEE is configured to allow reduced power consumption during periods of lower data activity. Physical layer transmitters (e.g., transmitter in Tx/Rx 142) may be configured to go into a lower power (“low power idle”) mode when no data is being sent. For example, these transmitters may be included in network controller 116 and/or management system 106.

The low power idle (LPI) mode may be entered in response to an LPI signal between the network controller 116 and management system 106. For example, an LPI signal may be generated based on LPI policy set by management system 106. Typically, the management system 106 may communicate (and/or change) high level LPI policy to be adopted by the host system. Triggering of the LPI signaling on the link (TX/RX) may be determined/generated locally by circuitry/agent in the network controller/host. For example, for a specific workload, the management system may be configured to change the policy so the host/network controller should not enter LPI state even when the link is not fully utilized. When there is data to transmit, a normal idle signal may be sent to “wake up” the transmitter system.

Thus, network controller 116′, including controller circuitry 140 is configured to receive host management data acquired by, e.g., agent 136, BMC 118, bridge controller 115 and to acquire network management data from the network controller 116′ itself. The management data may be acquired without significant activity by processor 110. Thus, acquiring the management data may not provide an additional processing burden for the processor. A greater level of security may be provided by performing the operations in the firmware of the network controller, rather than an application executing on the processor 110. Once the management data has been gathered by the network controller 116′, the network controller 116′ is configured to provide the management data to the management system 106 using Tx/Rx 142.

The management system 106 is configured to receive the management data from network controller 116, to analyze the management data and to make decisions regarding operation of host device 102 and/or network 104, based, at least in part on the received management data and policy. The management system 106 may receive similar management data from Node(s) 108A, . . . , 108N. Management system 106 and host device 102 (and network controller 116) may be configured to implement any network-related management protocol, including vendor-specific protocols as well as protocols corresponding to standards. Network-related management protocols include, but are not limited to, Simple Network Management Protocol (SNMP), NetFlow, Network Data Management Protocol (NDMP), OpenFlow control, and/or open flow configuration protocol, e.g., NetConf (Network Configuration Protocol), etc. The management protocols may include other XML/RPC (Extensible Markup Language/Remote Procedure Call) protocols.

SNMP is a component of the Internet Protocol Suite as defined by the Internet Engineering Task Force (IETF), e.g., Structure of Management Information Version 2 (SMIv2), dated April 1999. NetFlow is a network protocol developed by Cisco Systems for collecting IP traffic information, e.g., Cisco IOS NetFlow, version 9. NDMP is an open standard protocol for enterprise-wide backup of heterogeneous network-attached storage, e.g., NDMP, version 4, dated April 2003. NetConf is a network configuration protocol developed by the IETF, published in December, 2006 (RFC 4741), revised and published June 2011 (RFC 6241). NetConf provides mechanisms to install, manipulate and delete the configurations of network devices via remote procedure calls. Thus, management system 106 and host device 102 (and network controller 116) may be configured to implement any of these network management protocols and later and/or related versions of these standards/protocols

Management system 106 includes processor(s) 160, memory 162, a bridge chipset 164 and a network controller 166. Similar to host device 102, the bridge chipset 164 may be included in processor 160. Management system 106 is configured to receive management data from network controller 116 and to provide management commands to the network controller based, at least in part, on the received management data. The management system may include a computing device, similar to a node 108A, . . . , 108N. The management system 106 is configured to provide network management functions via modules executing on the computing device. Processor(s) 160 are configured to perform operations associated with management system 106, as described herein. Network controller 166 is configured to couple management system 106 to network 104, host device 102 and/or node(s) 108A, . . . , 108N. For example, network controller 166 may correspond to network controller 116′.

Memory 162 is configured to store system management module 170, network system data 172, network system policies 174 and workload scheduler module 176. Processor(s) 160 are configured to execute system management module 170 to perform operations associated with management system 106. For example, system management module 170 is configured to receive the management data provided by network controller 116. System management module 170 may be configured to analyze the management data based at least in part on network system data 172 and/or network system policies 174. For example, network system data may include network topology information, node information, usage information, link status information between nodes (link up/down, link speed, half/full duplex), Flow Control events, requeues, retransmits, etc. Network system data may further include, QoS information, traffic engineering policies, multi-pathing information, load balancing policies, etc. Network-wide policies may be determined based, at least in part on other application data, including type of workloads, virtual machines and other physical machine information. Such information may also be used by the management system.

Network system policies 174 may include policies for performing flow control based, at least in part on, management data from the network controller 116. For example, policies may include rerouting network flow based on network management data, Quality of Service (QoS), energy efficiency, geolocation, datacenter redundancy, etc. For example, if there are multiple paths between a source and destination, the management system 106 may be configured to utilize SDN techniques to reroute flows through optimum paths. For example, ECMP (Equal Cost Multiple Path) policies may be modified. In another example, the QoS policy may be modified to provide additional bandwidth for flows, and/or may utilize a better traffic class, etc. In another example, policy may indicate that an unutilized or under-utilized server, e.g., host device 102, in a plurality of interconnected servers should be powered down for energy savings, and powered up when the usage increases. In another example, workloads may be moved to underutilized servers to distribute workloads more evenly. Workload scheduler module 176 may be configured to perform workload scheduling. Workload scheduler module 176 may be configured to schedule workloads, move workloads and/or to adjust network forwarding flows, based at least in part, on host management data. Such workload scheduling, moving and/or adjusting may be based on one or more policies that may be set by a system administrator.

Thus, based, at least in part, on management data acquired by network controller 116, including network management data, and host management data acquired by agent 136, BMC 118 and/or bridge controller 115, a remote management system, e.g., management system 106, may be configured to perform network management functions based on the management data and policies. The management data may be analyzed and management commands may be generated based, at least in part, on the management data and network management policy. The network system commands may affect flow control, power management, etc.

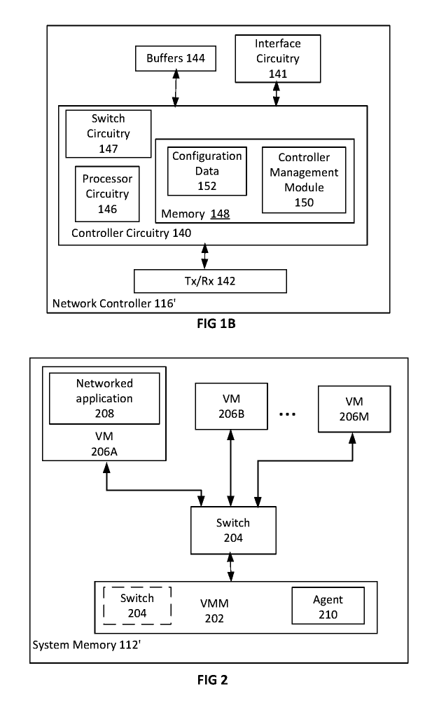

FIG. 2 is an example of a virtual machine 200 architecture consistent with one embodiment of the present disclosure. System memory 112′ corresponds to system memory 112 of FIG. 1. System 112′ may be configured to store a Virtual Machine Monitor (VMM) 202, a software switch 204 and a plurality of Virtual Machines (VMs) 206A, . . . , 206M. In some embodiments, software switch 204 may be included in VMM 202. VM 206A may include a networked application 208 and VMM (i.e., hypervisor) 202 may include agent 210. Switch 204 is configured to switch network traffic (e.g., network traffic from/to network controller 116) between VMs 206A, . . . , 206M. Agent 210 is configured to perform similar functions as agent 136. Thus, agent 210 may acquire management data related to VMM 202 and/or VMs 206A, . . . , 206M and provide the management data to network controller 116. In this example, commands from the management system 106 received in response to management data sent may be configured to modify configuration of switch 204. Thus, in this example, switch 204 may be programmable.

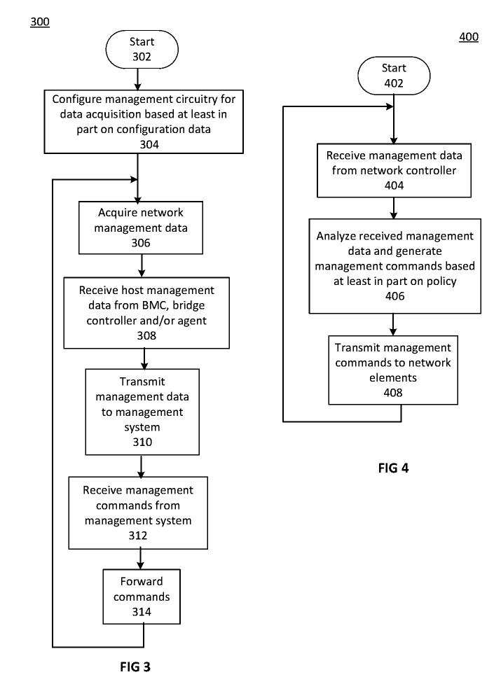

FIG. 3 illustrates a flowchart 300 of exemplary operations of a network controller consistent with one embodiment of the present disclosure. The operations may be performed, for example, by network controller 116, 116′. In particular, flowchart 300 depicts exemplary operations configured to acquire network management data from the network controller and host management data from an agent, BMC and/or bridge controller and to provide the network and host management data to the management system.

Program flow may begin at start 302. Operation 304 includes configuring management circuitry for data acquisition based, at least in part, on configuration data. For example, management circuitry includes controller circuitry 140 and may include agent 136, BMC 118 and/or bridge controller 115. Network management data may be acquired at operation 306. Operation 308 includes receiving host management data from, e.g., agent, BMC and/or bridge controller. Operation 310 may include transmitting management data to the management system. Management commands may be received from the management system at operation 312. The received management commands may be forwarded to the appropriate circuitry at operation 314. The appropriate circuitry may correspond to programmable network element(s) included in the network controller, host device and/or network. Program flow may then return to operation 306, acquiring network management data.

FIG. 4 illustrates a flowchart 400 of exemplary operations of a management system consistent with one embodiment of the present disclosure. The operations may be performed, for example, by management system 106. In particular, flowchart 400 depicts exemplary operations configured to analyze received management data, to generate commands based on the received management data and policy, and to provide the commands to an appropriate programmable network element. Program flow may begin at Start 402. Management data may be received at operation 404. For example, management data may be received from network controller 116. Operation 406 includes analyzing received management data 406. For example, the received management data may be analyzed based on policy. Operation 406 may further include generating management commands based, at least in part, on policy. Operation 408 includes transmitting management commands to programmable network element(s). For example, the programmable network element(s) may be included in a host device, e.g., host device 102, and/or network 104. Programmable network element(s) in the host device may be included in a network controller, a VM and/or a VMM. The management commands may be configured to perform flow control. In an embodiment, the management commands may be configured to enhance energy efficiency by powering down underutilized or unutilized servers. Program flow may then return to operation 404.

While FIGS. 3 and 4 illustrate various operations according to an embodiment, it is to be understood that not all of the operations depicted in FIGS. 3 and 4 are necessary for other embodiments. Indeed, it is fully contemplated herein that in other embodiments of the present disclosure, the operations depicted in FIGS. 3 and 4 and/or other operations described herein may be combined in a manner not specifically shown in any of the drawings, but still fully consistent with the present disclosure. Thus, claims directed to features and/or operations that are not exactly shown in one drawing are deemed within the scope and content of the present disclosure.

As used in any embodiment herein, the term “module” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU and/or other programmable circuitry. Also, it is intended that operations described herein may be distributed across a plurality of physical devices, such as processing structures at more than one different physical locations. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

Network 104 may comprise a packet switched network. Network controller 116 may be capable of communicating with node(s) 108A, . . . , 108N and/or the management system 106 using a selected packet switched network communications protocol. One exemplary communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, network controller 116 may be capable of communicating with node(s) 108A, . . . , 108N and/or the management system 106, using an X.25 communications protocol. The X.25 communications protocol may comply or be compatible with a standard promulgated by the International Telecommunication Union-Telecommunication Standardization Sector (ITU-T). Alternatively or additionally, network controller 116 may be capable of communicating with node(s) 108A, . . . , 108N and/or the management system 106, using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, network controller 116 may be capable of communicating with node(s) 108A, . . . , 108N and/or the management system 106, using an Asynchronous Transfer Mode (ATM) communications protocol. The ATM communications protocol may comply or be compatible with an ATM standard published by the ATM Forum titled “ATM-MPLS Network Interworking 1.0” published August 2001, and/or later versions of this standard. Of course, different and/or after-developed connection-oriented network communication protocols are equally contemplated herein.

Thus, a network controller, e.g., network controller 116 and controller circuitry 140, may be configured to acquire management data and to provide the management data to a remote management system. The management system may then analyze the received management data and may generate management commands based, at least in part, on the received data and policy. The management system may then provide the management commands to the host device, network controller and/or network elements included in network 104.

The management data may thus be provided without increasing processor utilization in the host device. The management data may be acquired by a network controller with an embedded controller that may be of limited functionality rather than a network controller with a high end processor. The operations may of course be performed by a high end processor, but such processing capability is not required.

According to one aspect there is provided a network system. The network system may include a management system, a host device and a network configured to couple the management system to the host device. The management system may include a system processor configured to execute a system management module, and a system memory configured to store network system data and network system policies. The host device may include a device processor configured to execute a networked application; a device memory configured to store an agent; and a network controller comprising controller circuitry configured to acquire network management data related to operation of the network controller and to receive host management data related to operation of the host device, and a transmitter configured to transmit the network and host management data to the management system. The network may include a programmable network element. The management system may be configured to generate a command based, at least in part, on the received network and host management data, the command configured reprogram the programmable network element to change a behavior of the programmable network element.

According to another aspect there is provided a method. The method may include acquiring, by a network controller, network management data related to operation of the network controller; receiving, by the network controller, host management data related to operation of a host device; and transmitting, by the network controller, the network and host management data to a management system via a network. The method may further include generating, by the management system, a command related to the received network and host management data, the command configured to reprogram a programmable network element to change a behavior of the programmable network element.

According to another aspect there is provided a host device. The host device may include a processor configured to execute a networked application; a memory configured to store an agent; a network controller and a programmable network element. The network controller may include controller circuitry configured to acquire network management data related to operation of the network controller and to receive host management data related to operation of the host device; a transmitter configured to transmit the network and host management data to a management system remote from the host device, and a receiver configured to receive a command from the management system, the command related to the transmitted management data. The received command is configured to reprogram the programmable network element to change a behavior of the programmable network element.

According to another aspect there is provided a system. The system may include one or more storage mediums having stored thereon, individually or in combination, instructions that when executed by one or more processors result in the following operations comprising: acquire network management data related to operation of a network controller; receive host management data related to operation of a host device; transmit the network and host management data to a management system via a network; and generate a command related to the received network and host management data, the command configured to reprogram a programmable network element to change a behavior of the programmable network element.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A network system, comprising:
a management system comprising:
a system processor configured to execute a system management module, and
a system memory configured to store network system data and network system policies;
a host device comprising:
a device processor configured to execute a networked application;
a device memory configured to store an agent; and
a network controller comprising controller circuitry configured to acquire network management data related to operation of the network controller and to receive host management data related to operation of the host device, and a transmitter configured to transmit the network and host management data to the management system; and
a network configured to couple the management system to the host device, the network comprising a programmable network element,
wherein the management system is configured to generate a command based, at least in part, on the received network and host management data, the command configured reprogram the programmable network element to change a behavior of the programmable network element.

2. The network system of claim 1, wherein the programmable network element is programmable by an application programming interface that corresponds to an OpenFlow Switch Specification.

3. The network system of claim 1, wherein the programmable network element is a switch, a bridge or a router.

4. The network system of claim 1, wherein the management system is configured to analyze the received network and host management data based on at least one of the network system data and the network system policies.

5. The network system of claim 1, wherein the system processor is further configured to execute a workload scheduler module configured to at least one of schedule, adjust or move a workload based, at least in part, on received host management data.

6. A method, comprising:
acquiring, by a network controller, network management data related to operation of the network controller;
receiving, by the network controller, host management data related to operation of a host device;
transmitting, by the network controller, the network and host management data to a management system via a network; and
generating, by the management system, a command related to the received network and host management data, the command configured to reprogram a programmable network element to change a behavior of the programmable network element.

7. The method of claim 6, wherein the command is configured to reprogram the programmable network element via an application programming interface that corresponds to an OpenFlow Switch Specification.

8. The method of claim 6, further comprising analyzing, by the management system, the received management data and generating the command based, at least in part, on a network system policy.

9. The method of claim 6, further comprising transmitting the command to the programmable network element by the management system.

10. The method of claim 6, wherein the programmable network element is a software switch.

11. A host device comprising:
a processor configured to execute a networked application;
a memory configured to store an agent;
a network controller comprising controller circuitry configured to acquire network management data related to operation of the network controller and to receive host management data related to operation of the host device, a transmitter configured to transmit the network and host management data to a management system remote from the host device, and a receiver configured to receive a command from the management system, the command related to the transmitted management data; and
a programmable network element, wherein the received command is configured to reprogram the programmable network element to change a behavior of the programmable network element.

12. The host device of claim 11, wherein the programmable network element is programmable by an application programming interface that corresponds to an OpenFlow Switch Specification.

13. The host device of claim 11, further comprising a baseboard management controller (BMC) configured to acquire host management data related to a state of the host device wherein the controller circuitry is configured to receive the host management data from the BMC.

14. The host device of claim 11, wherein the controller circuitry is an embedded controller comprising one of a microcontroller, an application specific integrated circuit (ASIC), a field programmable gate array (FPGA) or a microengine.

15. The host device of claim 11, wherein at least one of the network and host management data is selected based, at least in part, on configuration data.

16. The host device of claim 15, wherein the memory is further configured to store a configuration file related to the configuration data and the agent is configured to provide the configuration data to the network controller.

17. A system comprising, one or more storage mediums having stored thereon, individually or in combination, instructions that when executed by one or more processors result in the following operations comprising:
acquire network management data related to operation of a network controller;
receive host management data related to operation of a host device; and
transmit the network and host management data to a management system via a network; and
generate a command related to the received network and host management data, the command configured to reprogram a programmable network element to change a behavior of the programmable network element.

18. The system of claim 17, wherein the command is configured to reprogram the programmable network element via an application programming interface that corresponds to OpenFlow, as set forth in the OpenFlow Switch Specification Version 1.1.0 Implemented (Wire Protocol 0x02) dated Feb. 28, 2011.

19. The system of claim 17, wherein the instructions that when executed by one or more processors results in the following additional operations:
analyze the received management data and generate the command based, at least in part, on a network system policy.

20. The system of claim 17, wherein the instructions that when executed by one or more processors results in the following additional operation:
transmit the command to the programmable network element by the management system.
